(19) United States
(12) Patent Application Publication
(10) Pub. No.: US 2014/0332398 A1
(43) Pub. Date: Nov. 13, 2014

(54) ELECTROCHEMICAL pH MEASUREMENT

(71) Applicant: SCHLUMBERGER TECHNOLOGY CORPORATION, Sugar Land, TX (US)

(72) Inventors: NATHAN S. LAWRENCE, WATON (GB); LYNNE CRAWFORD, HARLOW (GB)

(73) Assignee: SCHLUMBERGER TECHNOLOGY CORPORATION, Sugar Land, TX (US)

(21) Appl. No.: 13/891,084

(22) Filed: May 9, 2013

(51) Int. Cl. G01N 27/30; C25D 9/04

(52) U.S. Cl. CPC G01N 27/302; C25D 9/04
USPC 205/333; 205/782

(57) ABSTRACT

An electrode for the determination of pH is made by depositing a phenolic compound on a conductive substrate, where the phenolic compound has a phenolic hydroxy group attached to a carbon atom on an aromatic ring and also has an oxygen atom connected through one other atom to an adjacent carbon atom of the aromatic ring such that this oxygen atom can form a hydrogen bond to the phenolic hydroxy group; and then electrochemically oxidising the immobilized phenolic compound in a one electron one proton oxidation so as to form a polymeric, water-insoluble, redox-active deposit on the conductive substrate. The electrode is useful for electrochemical determination of pH and is capable of measuring pH of an unbuffered aqueous liquid.

### BACKGROUND

There are numerous circumstances in which it is desirable to detect, measure or monitor a constituent of a fluid. One of the commonest requirements is to determine hydrogen ion concentration (generally expressed on the logarithmic pH scale) in aqueous fluids which may for example be a water supply, a composition in the course of production or an effluent. The determination of the pH of a solution is one of the most common analytical measurements and can be regarded as the most critical parameter in water chemistry. Merely by way of example, pH measurement is important in the pharmaceutical industry, the food and beverage industry, the treatment and management of water and waste, chemical and biological research, hydrocarbon production and water supply monitoring. Nearly all water samples will have their pH tested at some stage during their handling as many chemical processes are dependent on pH.

One approach to pH measurements employs a solid-state probe utilising redox chemistries at the surface of an electrode. Some redox active compounds (sometimes referred to as redox active species) display a redox potential which is dependent on hydrogen ion concentration in the electrolyte. By monitoring this redox potential electrochemically, pH can be determined. Voltammetry has been used as a desirable and convenient electrochemical method for monitoring the oxidation and reduction of a redox active species and it is known to immobilise the redox active species on or in proximity to an electrode.

Prior literature in this field has included WO2005/066618 which disclosed a sensor in which two different pH sensitive molecular redox systems and a pH insensitive ferrocene reference were attached to the same substrate. One pH sensitive redox system was anthraquinone (AQ) and the second was either phenanthrenequinone (PAQ) or alternatively was N,N′-diphenyl-p-phenylenediamine (DPPD). WO2007/034131 disclosed a sensor with two redox systems incorporated into a copolymer. WO2010/001082 disclosed a sensor in which two different pH sensitive molecular redox systems were incorporated into a single small molecule which was immobilized on an electrode. WO2010/111531 described a pH metering device using a working electrode in which a material which is sensitive to hydrogen ions (the analyte) was chemically coupled to carbon and immobilised on the working electrode.

The pH sensitive redox systems in these disclosures have been compounds which undergo a 2-electron 2-proton redox reaction. In many instances the compounds have been quinones which undergo reversible redox conversion to and from hydroquinones.

It is known that phenolic compounds with a single hydroxy group can undergo electrochemical oxidation by a 1-electron 1-proton oxidation. It has been reported that the products of such oxidation are reactive and former polymers, so that the oxidation reaction is irreversible.

An issue with electrochemical sensors (particularly those involving detection mechanisms involving proton transfer) is the ability to make electrochemical measurements without a buffer and/or similar species that can facilitate proton transfer reactions. A pH sensor is often tested and calibrated using buffer solutions which have stable values of pH. The concentration of buffer in such a solution may be 0.1 molar or more. It has been discovered that electrochemical sensors utilising an immobilized redox compound can give good results when used in a buffered aqueous solution, and yet fail to do so when used in an unbuffered solution. Consequently measurements can be particularly difficult, and error prone, in low ionic strength media, without pH buffering species and/or other species facilitating proton transfers. Measuring the pH of rainwater, and natural waters with very low mineralization, is noted as being particularly difficult.

### SUMMARY

This summary is provided to introduce a selection of concepts that are further described below. This summary is not intended to be used as an aid in limiting the scope of the subject matter claimed.

We have now found that a pH sensing electrode which is able to make measurements in unbuffered or weakly buffered aqueous solution can be made using certain substituted phenolic compounds. We now disclose here a method of making an electrode for the determination of pH, which comprises
depositing a phenolic compound on a conductive substrate,
   where the phenolic compound has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group; and
electrochemically oxidising the phenolic compound in a one electron one proton oxidation so as to form a polymeric, water-insoluble, redox-active deposit on the conductive surface.

The oxygen atom may be part of a group in which there is a double bond to the oxygen atom, such as a carbonyl, nitro or sulpho group. A carbonyl group may be part of an aldehyde, keto or ester group. The relationship between this oxygen atom and the phenolic hydroxyl can be depicted as a partial structure:

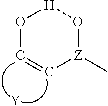

in which Y and the two carbon atoms connected to it are an aromatic ring with phenolic hydroxyl attached, and the oxygen atom joined to the ring through atom Z is able to participate in a hydrogen bond to the phenolic hydroxyl, as shown by a dotted line.

These phenolic compounds may be much less water-soluble than phenol itself and so may be applied to the conductive substrate by a process which deposits them onto the substrate. This may be application as a dispersion or solution in an organic solvent which is allowed to evaporate, leaving the phenolic compound immobilised on the surface of the substrate. Oxidation and polymerisation of the immobilised phenolic compound can then be brought about with the conductive substrate immersed in an electrolyte solution, which may be an aqueous solution and may be a buffer solution.

The conductive substrate may be metallic, for example a thin layer of platinum on an insulating substrate, or it may be a conductive form of carbon. Forms of carbon which have been used for electrodes, and which may be used as the substrate here, include glassy carbon, carbon fibres, carbon black, various forms of graphite, carbon paste, carbon epoxy and carbon nanotubes. The conductive substrate may for instance be a graphite electrode or a glassy carbon electrode.

Another aspect of the present disclosure provides an electrode for the determination of pH, comprising a conductive substrate bearing a water-insoluble, redox-active deposit which is a polymeric reaction product of the oxidation of a compound which has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group.

We have found that an electrode bearing the polymeric deposit resulting from oxidation and polymerisation of such a phenolic compound can be used for a measurement of pH of an aqueous liquid which contains little or no buffer. The potential at which the redox reaction gives maximum current flow is dependent on the pH of the liquid.

Another aspect of this disclosure therefore provides a method of measuring the pH of an aqueous liquid wherein the concentration of buffer (if any) is not greater than 0.01 molar, comprising
preparing a sensor electrode by applying a phenolic compound to a conductive substrate,
   where the phenolic compound has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group;
electrochemically oxidising the phenolic compound in a one electron one proton oxidation so as to form a polymeric, water-insoluble, redox-active deposit on the conductive substrate; and
exposing the aqueous liquid to the sensor electrode and observing the redox reaction of the deposit on the sensor electrode.

Observing the redox reaction may be carried out by voltammetry which applies variable potential to the sensor electrode and determines the applied potential at a maximum current for redox reaction of the compound. More specifically, measuring pH may comprise applying a potential to the electrode in a sweep over a range sufficient to bring about at least one oxidation and/or reduction of the redox active deposit; measuring potential or potentials at the peak current for one or more said oxidation and/or reductions; and processing the measurements to give a determination of pH. If more than one potential is measured, the method may comprise averaging at least two potentials corresponding to peak currents and processing the average to determine the pH. Determination of pH from potential values may be done by comparing the potential with values observed in a calibration using buffer solutions of known pH.

For use with an unbuffered or weakly buffered liquid, the phenolic compounds may be devoid of any ionised or ionisable basic or acidic group other than phenolic hydroxyl, such as an amino, carboylic acid or possibly sulphonic acid group because this may disturb the pH in the vicinity of the electrode. A carbonyl group able to participate in hydrogen bonding as mentioned above may therefore be contained within an ester, aldehyde or ketone structure rather than in a carboxylic acid group. By way of illustration, instances of phenolic compounds which includes such structures are

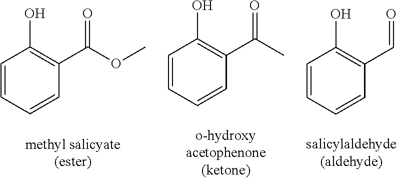

Concentration of buffer is the total concentration of partially dissociated acid, base and/or salt which provides the stabilization of pH. The method and/or the use of a sensor may be carried out to measure the pH of an aqueous liquid which contains buffer at a concentration of at least 10⁻⁶ molar (0.001 mM) or possibly at least 5×10⁻⁶ molar (0.005 mM), or at least 10⁻⁵ molar or at least 10⁻⁴ molar. The concentration of buffer may perhaps be no more than 5×10⁻³ molar (5 mM) or even no more than 1 mM.

Because measurement can be made when buffer is at a low concentration, measurement can be performed on aqueous liquids where a small concentration of buffer may be present as a consequence of the origin of the liquid, for example measurement may be carried out on biological samples and natural products containing small concentrations of organic acids which are not fully ionized and provide some buffering of pH.

It is envisaged that some embodiments of the method may be carried out to measure the pH of aqueous liquid with a pH which is within two or three units of neutral. Thus the liquid may be mildly acidic from pH 4 or pH 5 up to pH 7 or mildly basic from pH 7 up to pH 9 or pH 10. The aqueous liquid may be liquid flowing within or sampled from equipment for processing the liquid and it may be a foodstuff or other material for human or animal consumption or an ingredient of such foodstuff or material. The aqueous liquid may possibly be one phase of a composition which is an emulsion, and it may be the continuous phase or a discontinuous phase of an emulsion.

Measurement of pH by the stated method can be carried out without measuring the buffer concentration. It is advantageous that the method can be employed when buffer concentration in the aqueous liquid is not known or is a parameter which cannot be controlled, without fear of an anomalous result because the concentration of buffer is low.

To carry out the determination pH, the sensor electrodes may be used as the working electrode of an electrochemical cell and maybe a component part of apparatus to determine pH. In a further aspect, the present disclosure provides apparatus to determine pH of water or other aqueous solution. Such apparatus may comprise:

an electrode for the determination of pH, comprising a conductive substrate bearing a water-insoluble, redox-active deposit which is the polymeric reaction product resulting from the oxidation of a compound which has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group;

means to apply potential to the electrode and observe current flow; and

a programmable computer connected and configured to receive current and/or voltage data from the electrode.

Such apparatus may be incorporated into equipment to process aqueous liquid, for instance process plant for water treatment, or to manufacture a pharmaceutical or a food product, and the computer which receives data from the sensor may be a computer which monitors or controls operation of that equipment. Thus this disclosure also provides equipment for processing water or other aqueous liquid, including:

a programmable computer operatively connected to control or monitor operation of the equipment,

an electrode for the determination of pH, comprising a conductive substrate bearing a water-insoluble, redox-active deposit which is a polymeric reaction product of the oxidation of a compound which has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group, and

means to apply potential to the electrode and observe current flow; wherein the computer is connected and configured to receive current and/or voltage data from the sensor.

Embodiments of apparatus may have a plurality of electrodes with the redox active deposit on one of the electrodes. An electrochemical sensor may also comprise a reference redox active compound, immobilized to the same or another electrode, where the oxidation and reduction of the reference redox active compound is substantially insensitive to pH.

Electrodes may be positioned in the equipment to be exposed to liquid flowing within the equipment, or taken from it as a sample, possibly by automated sampling under control of the computer. A programmable computer may monitor the proper operation of equipment and give a readout to a human operator, or the computer may itself control operation of the equipment.

### BRIEF DESCRIPTION OF THE DRAWINGS

FIGS. 1 to 5 show the results of square wave voltammetry carried out on electrodes with various phenolic compounds deposited on them;

FIG. 6 is a graph of potential at peak current against pH;

FIG. 7 shows the results of voltammetry carried out with an electrode prepare from salicylaldehyde;

FIG. 8 is a diagrammatic illustration of the parts of a sensor;

FIG. 9 shows another electrode construction;

FIG. 10 illustrates the geometrical surface layout of the surface of a sensor;

FIG. 11 is a perspective view, partially cut-away, of a flow line fitted with an electrochemical sensor incorporating the surface of FIG. 10;

FIG. 12 is a diagrammatic view of a flow line with means for taking samples and measuring the pH of the samples;

FIG. 13 is a diagrammatic illustration of a cable-suspended tool for testing water;

FIG. 14 illustrates an example of an electrochemical sensor as part of a wireline formation testing apparatus in a wellbore; and

FIG. 15 illustrates a working electrode covered at least in part by a polymer layer.

### DETAILED DESCRIPTION

An electrode was prepared using the phenolic compound salicylaldehyde which has the structure

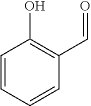

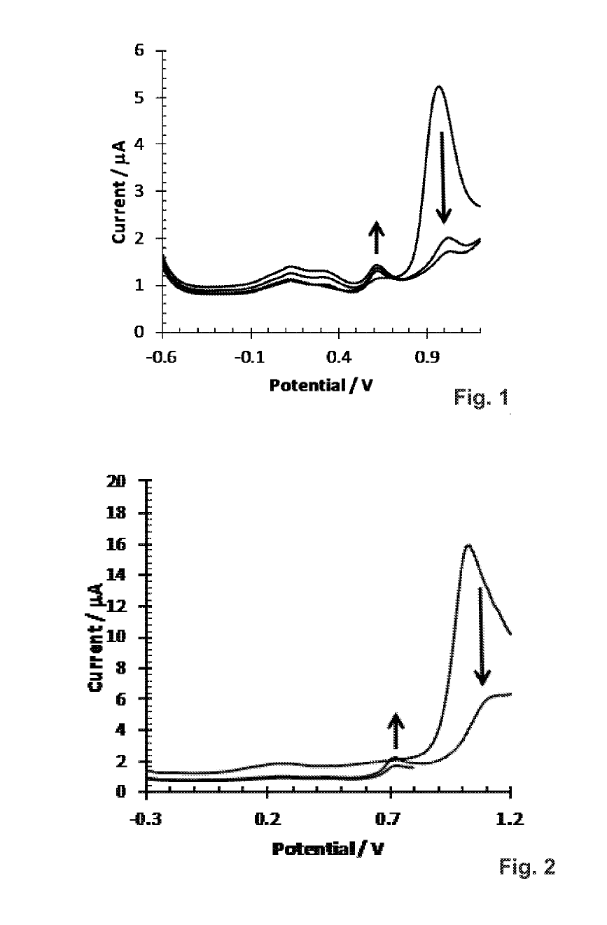

Powdered salicylaldehyde was dissolved in dichloromethane at a concentration of 1 mg/ml. A 10 microliter (10 μL) aliquot of this solution was spread onto the surface of a glassy carbon electrode and allowed to dry. The electrode was then used as the working electrode of an electrochemical cell in which the electrolyte was pH 4 buffer. Square wave voltammetry (Frequency=25 Hz, Step Potential=2 mV, Amplitude=0.02V) was carried out to assess the electrochemical response. FIG. 1 shows successive square wave voltammetric responses and it can be seen that the initial scan shows a large oxidative wave with peak current at +0.95V. The second and subsequent scans show a large decrease in this oxidative peak current (indicated by a downward arrow) and the emergence (indicated by an upward arrow) of a new redox wave with peak current at +0.59V.

The above electrode preparation procedure was repeated with a number of variations:
a) The same materials were used, but the electrolyte was stirred. The same results were obtained indicating that the product of the electrochemical oxidation was not dissolving in the electrolyte but was remaining on the electrode.
b) The pH4 buffer was replaced with pH 2 Britten-Robinson buffer. The square wave voltammetric responses are shown in FIG. 2. The initial oxidative wave was at +1.01V, with a new wave emerging at +0.71V upon repeated scanning
c) The salicylaldehyde was replaced with salicylic acid which did not dissolve but remained as a dispersion of finely powder in the dichloromethane. A very similar voltammetric response was observed in pH4 buffer with the initial oxidative peak current at +0.99V and emergence of a new redox wave with peak current at 0.66V. This showed that application of a phenolic compound to the glassy carbon electrode surface could be carried out using a dispersion in place of a solution.
d) The salicylaldehyde was replaced with methyl salicylate. The results were similar to those with salicylaldehyde.
e) In three separate experiments, the salicylaldehyde was replaced with 2-hydroxybenzylalcohol, and then with 2-hydroxypropiophenone and then with 2-nitrophenol. Their structures are

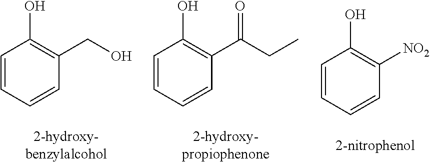

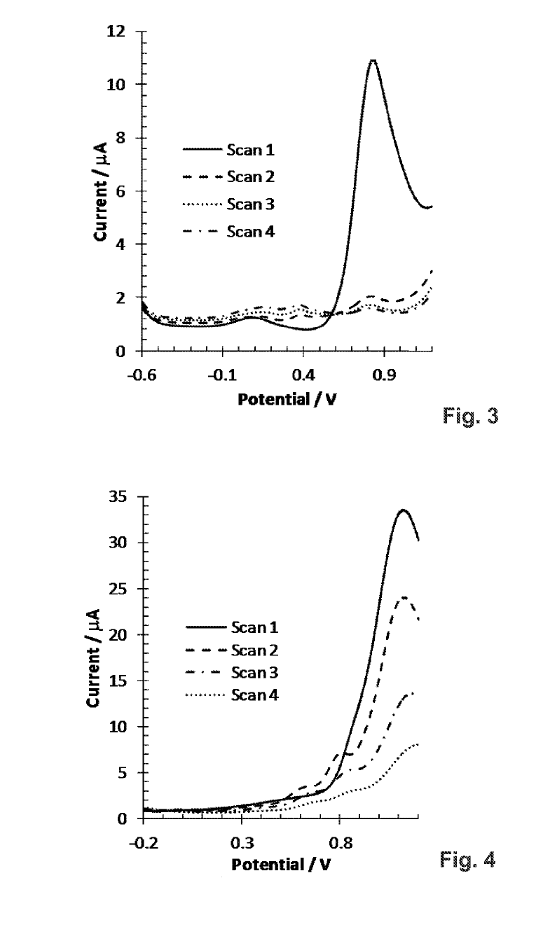

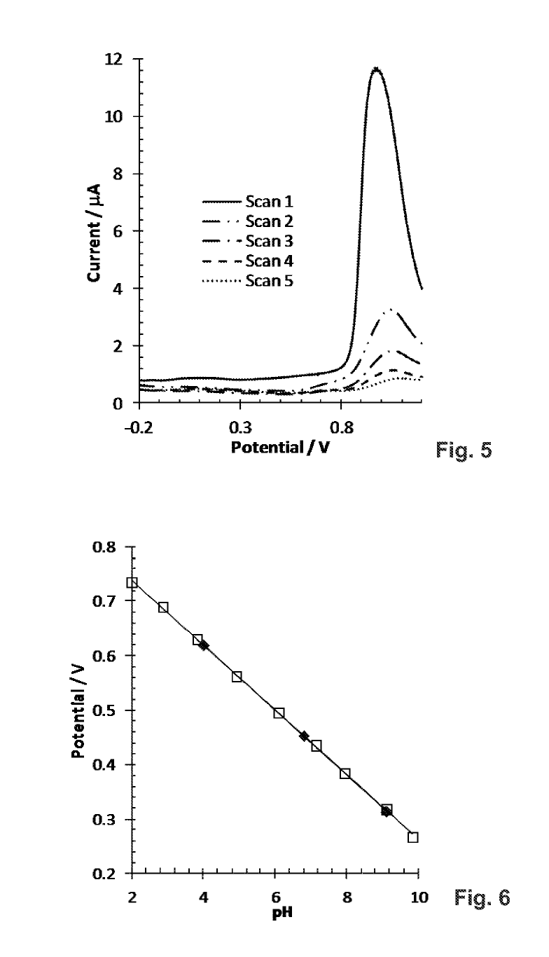

The results of square wave voltammetry in pH 4 buffer solution are shown in FIGS. 3, 4 and 5. An initial large oxidation wave was observed at +0.82V, +1.12V and +0.98V respectively. On the second and subsequent scans a large decrease was observed in this wave and a new wave emerged at +0.35V, +0.80V and +0.72V respectively.

### Using the Electrodes

An electrode prepared as above using salicylaldehyde was used as the working electrode of an electrochemical cell which was also provided with a silver/silver chloride reference electrode and a stainless steel counter electrode. The electrolyte in the cell was buffered electrolyte having pH increased in steps from pH2 to pH10. Square wave voltammetry was carried out at each pH. The potential at which oxidative current reached a peak progressively shifted to lower values as pH was increased. FIG. 6 is a plot of these potential values against pH. The data points are shown as open squares and lie on a straight line with a slope of 60.4 mV/pH unit, which is consistent with the species formed by the initial electrochemical oxidation of salicylaldehyde undergoing an n-electron n-proton redox process.

This experiment was repeated using stirred buffer solutions as electrolyte. The results are included in FIG. 6 as filled diamonds. They lie on the same line. Thus stirring the electrolyte did not change the results, confirming that the redox-active deposit on the electrode was not dissolving in the electrolyte.

Similar results were obtained with electrodes prepared using 2-hydroxybenzylalcohol, 2-hydroxypropiophenone and 2-nitrophenol, showing that the deposits obtained from electrochemical oxidation of all of these phenolic compounds were redox active and sensitive to pH of the electrolyte.

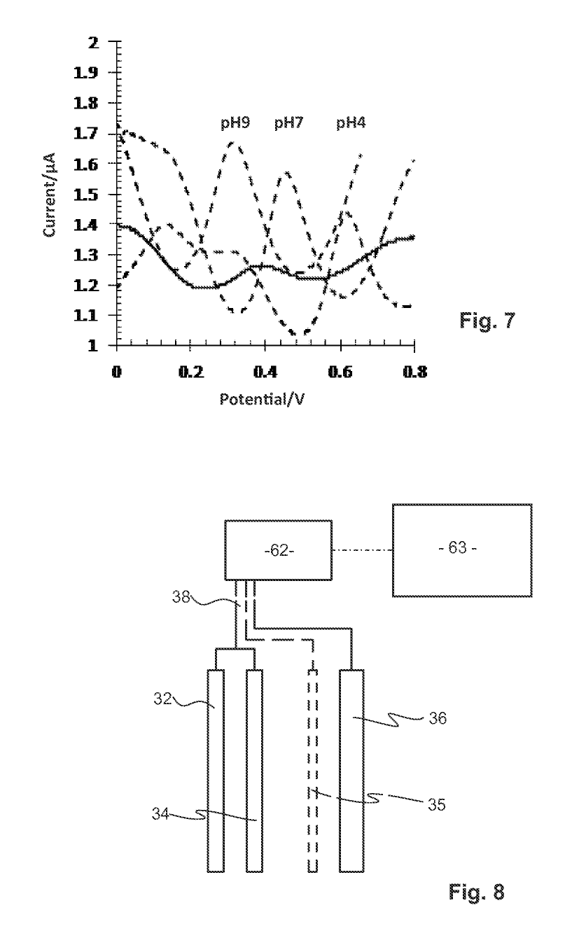

An electrode prepared as above using salicylaldehyde was again used as the working electrode of an electrochemical cell, and square wave voltammetry was carried out with three buffer solutions having pH 4, 7 and 9 as electrolyte. The voltammetric responses are shown as dashed lines in FIG. 7. This was then repeated using unbuffered water containing a small concentration of dissolved salt as electrolyte. The voltammetric response is shown as a solid line in FIG. 7. The pH of this water was determined from the potential of peak current as pH 7.69. This was in excellent agreement with the pH value measured using a commercial glass electrode.

Analogous experiments were carried out using electrodes prepared as above using salicylic acid, 2-hydroxypropiophenone, 2-hydroxybenzylalcohol and 2-nitrophenol. The resulting data is summarised in the following table.

| | pH measured | pH determined | |
|---|---|---|---|
| | with glass | using electrode as | Sensitivity |
| Starting Compound | electrode | described | (mV/pH) |
| salicylic acid | 7.65 | 3.91 | 62 |
| salicylaldehyde | 7.65 | 7.69 | 60.4 |
| methyl salicylate | 7.28 | 7.18 | |
| 2-hydroxybenzylalcohol | 7.65 | 8.02 | 58.7 |
| 2-hydroxypropiophenone | 7.4 | 7.3 | 57.6 |
| 2-nitrophenol | 7.20 | 7.15 | 53 |

The data in the table shows that salicylaldehyde and 2-hydroxypropiophenone provide electrodes suitable for measuring pH of an unbuffered or weakly buffered solution. The electrode prepared using hydroxybenzylalcohol was not so accurate, attributed to a weaker hydrogen bond between the two hydroxyl groups. The electrode prepared using salicylic acid gave an inaccurate result, suggesting that the carboxylic acid functionality contained within the molecule was controlling the pH of the unbuffered electrolyte within the diffusion layer of the electrode.

In some embodiments, a redox active deposit, as disclosed here, which is sensitive to the analyte concentration/pH may be used jointly with a redox active compound which is substantially insensitive to the concentration of analyte/pH. This species which is independent of analyte concentration may then function as a reference and the potential of the sensitive compound may be determined relative to the potential of the compound which is insensitive to the concentration of analyte/pH. Possible reference molecules, insensitive to hydrogen ion concentration are K₅Mo(CN)₈ and molecules containing ferrocene such as potassium t-butylferrocene sulfonate.

The redox active deposit, as disclosed here, may be formed on part of the area of a conductive substrate and a reference redox active compound which is substantially insensitive to the concentration of analyte/pH may be immobilized on another part of the same substrate to form an electrode with both redox systems or it may be immobilized on another electrode. The two electrodes may then be connected together so that only a single voltammetric sweep is required.

An electrode as disclosed herein could be incorporated into a wide variety of tools and equipment. Possibilities include use in tools which are located permanently downhole, use in tools which are conveyed downhole, for instance at the head of coiled tubing or by drillpipe or on a wireline, use in underground, undersea or surface pipeline equipment to monitor liquid flowing in the pipeline, and use in a wide variety of process plant at the Earth's surface, including use in water treatment.

FIG. 8 diagrammatically illustrates component parts which may be used to measure pH. There is a working electrode 32 comprising a conductive substrate material on which there is a redox active deposit formed by oxidation and polymerization of a phenolic compound as described above. A second electrode 34 which also comprises a conductive material but has a substituted ferrocene immobilized on its surface to serve as a voltage reference. There is a counter electrode at 36. All the electrodes are connected as indicated at 38 to a potentiostat 62 or other control unit which provides electric power and measurement. This arrangement avoids a need for a standard reference electrode such as a standard calomel electrode. However, another possibility would be to provide such a standard electrode, as shown by broken lines at 35 and possibly dispense with the ferrocene electrode 34. The various electrodes are immersed in or otherwise exposed to fluid whose pH is to be measured.

Measuring apparatus may comprise both a sensor and a control unit providing both electrical power and measurement. A control unit such as 62 may comprise apparatus such as a power supply, voltage supply, or potentiostat for applying an electrical potential to the working electrode 32 and also a detector, such as a voltmeter, a potentiometer, ammeter, resistometer or a circuit for measuring voltage and/or current and converting to a digital output, for measuring a potential between the working electrode 32 and the counter electrode 36 and/or the reference electrode 34 or 35 and for measuring a current flowing between the working electrode 32 and the counter electrode 36 (where the current flow will change as a result of the oxidation/reduction of a redox species). The control unit may in particular be a potentiostat. Suitable potentiostats are available from Eco Chemie BV, Utrecht, Netherlands.

A control unit 62 which is a potentiostat may sweep a voltage difference across the electrodes and carry out voltammetry so that, for example, linear sweep voltammetry, cyclic voltammetry, or square wave voltammetry may be used to obtain measurements of the analyte using the electrochemical sensor. The control unit 62 may include signal processing electronics.

A control unit 62 may be connected to a computer 63 which receives current and/or voltage data from the sensor. This data may be the raw data of applied voltage and the current flowing at that voltage, or may be processed data which is the voltage at peak current. A control unit 62, such as a potentiostat may itself be controlled by a programmable computer 63 giving a command to start a voltage sweep and possibly the computer will command parameters of the sweep such as its range of applied voltage and the rate of change of applied voltage.

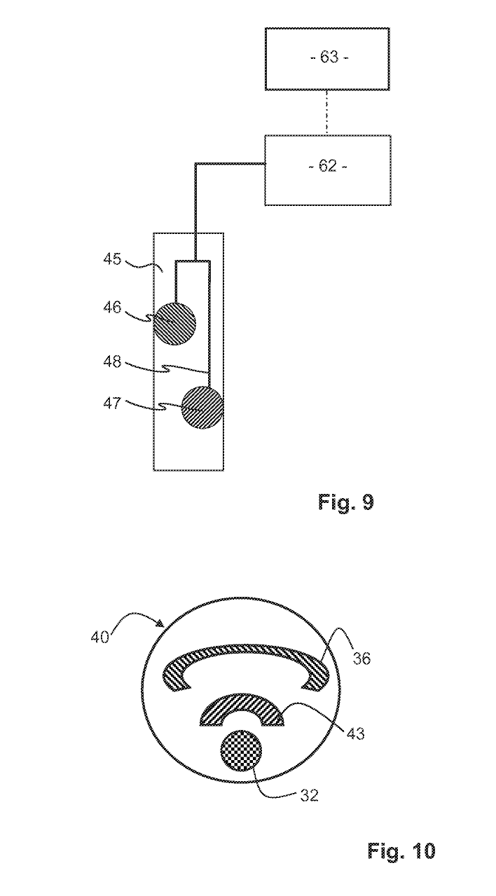

FIG. 9 shows a possible variation. A conductive paste is printed on one area 46 of an insulating substrate 45 and a redox active deposit is formed on the conductive paste by oxidation and polymerization of a phenolic compound. A second conductive paste containing a pH insensitive ferrocene compound is printed on an area 47. Both areas 46, 47 are connected together by conductive tracks 48 on the substrate which are connected as shown to a control unit 62 which may in turn be connected to a programmable computer 63 receiving data from the sensor.

FIG. 10 shows a possible geometric configuration or layout for the surface 40 of a sensor which is exposed to the fluid to be tested, which may, merely by way of example be a wellbore fluid. The surface includes a disk shaped working electrode 32, a second electrode 43, which may be a ferrocene electrode or an external reference electrode such as a silver/silver chloride electrode, and a counter electrode 36.

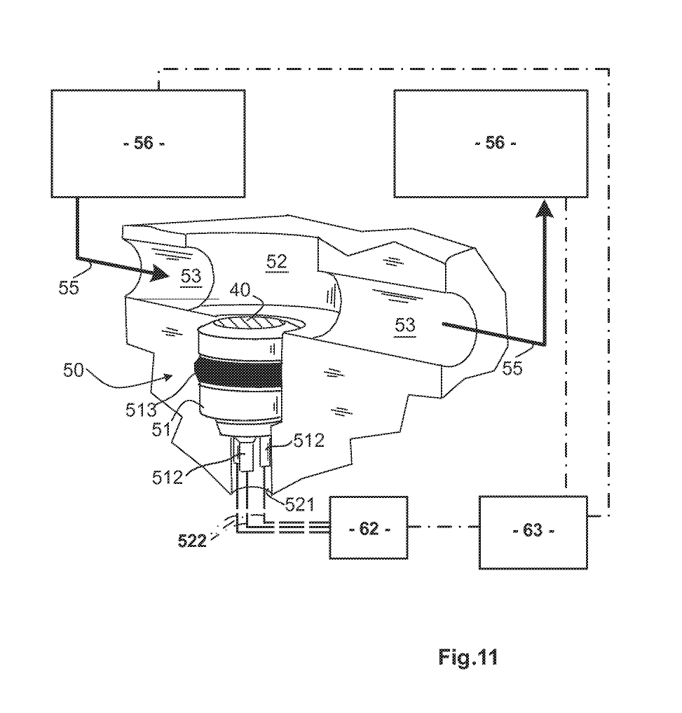

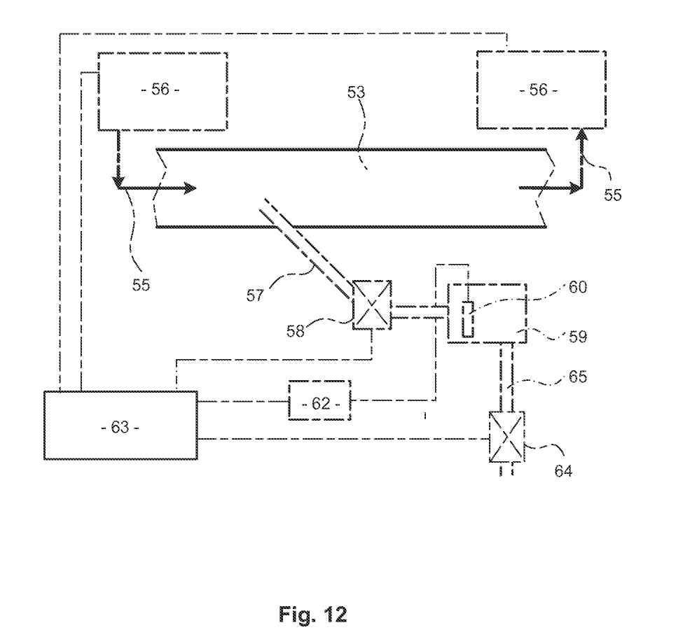

A schematic of a microsensor 50 incorporating such a surface is shown in FIG. 11. The surface 40 of a sensor 50 is exposed to liquid in a channel 53 which may be part of a flow line for a material flowing into, within or out from equipment which is a process plant for an aqueous liquid. Flow is indicated by arrows 55. The body 51 of the sensor 50 is fixed into the end section of an opening 52. The body carries the electrode surface 40 and has contacts 512 located in a small channel 521 at the bottom of the opening 52. A sealing ring 513 protects the contact points and electronics from the fluid to be tested that passes under operation conditions through the channel 53. Other parts of the process plant are indicated schematically by boxes 56. The contacts 512 of the sensor are electrically connected by cables 522 to a potentiostat 62 for voltage supply and current measurement. This potentiostat 62 receives operating commands from a computer 63 and sends data, consisting of the applied potential and observed current to the computer 63. The computer is also connected, as shown by chain dotted lines, to other parts of the process plant 56 and controls its operation, such as by operating valves and heaters (not shown separately) within the plant 56.

FIG. 12 shows diagrammatically an arrangement for periodically taking samples and determining pH. An aqueous liquid to be sampled flows in line 53 as shown by arrows 55. A sampling tube 57 projects into the flow path. When a sample is to be taken, valve 58 is opened, allowing liquid to flow through the tube 57 into chamber 59. This chamber 59 has a sensor 60 within it for measuring the pH of fluid within the chamber 59. This sensor may be of the type shown in FIG. 8 or the type shown in FIG. 9. It is connected to a potentiostat 62. The line 53 is part of equipment 56 for processing water or other aqueous liquid. This plant is controlled by a programmable computer 63 which also operates the valve 58 when required and a further valve 64 for draining the chamber 59 through tube 65. Connections to the computer are shown by chain dotted lines. The computer may be programmed to maintain stable pH, so that pH measurement forms part of a control system, or it may monitor pH and alert a human supervisor if pH goes out of an acceptable range. The latter might be done as a check on incoming water or other aqueous feedstock, for instance.

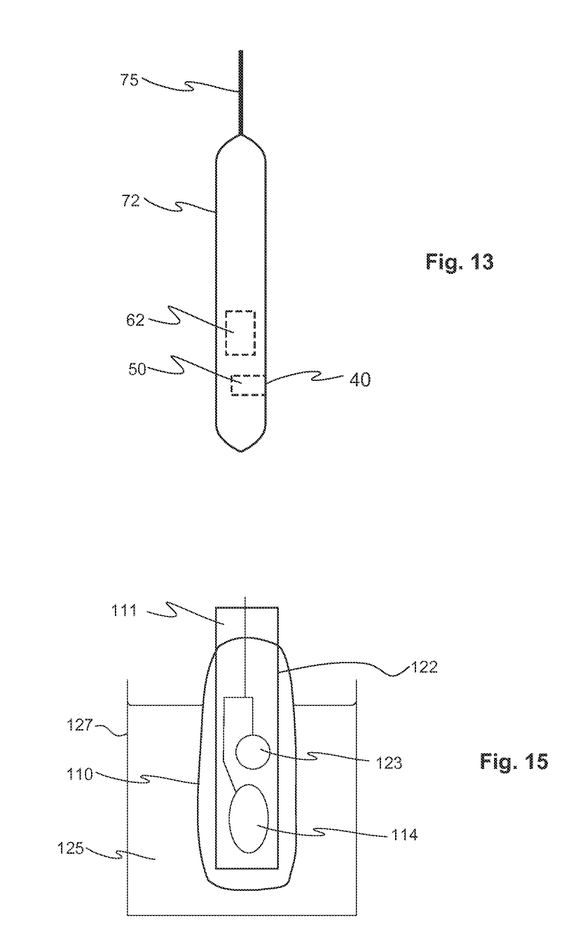

An application of an embodiment of the present invention may be in the monitoring of underground bodies of water for the purposes of resource management. From monitoring wells drilled into the aquifers, one or more sensors may be deployed on a cable from the surface—either for short duration (as part of a logging operation) or longer term (as part of a monitoring application). FIG. 13 illustrates a tool for investigating subterranean water. This tool has a cylindrical body 72 which is suspended from a cable 75. A sensor unit similar to the body 51 shown in FIG. 16 is accommodated within the body 72 so that its surface 40 is exposed to the subterranean water. The tool also encloses also encloses a unit 62 which is a potentiostat for supplying voltage to the electrodes of the sensor unit 51, measuring the current which flows and transmitting the results to the surface.

The deployment of such a pH sensor within producing wells on a cable may provide information on produced water quality. Also, the pH sensor may be deployed in injection wells, e.g. when water is injected into an aquifer for later retrieval, where pH may be used to monitor the quality of the water being injected or retrieved.

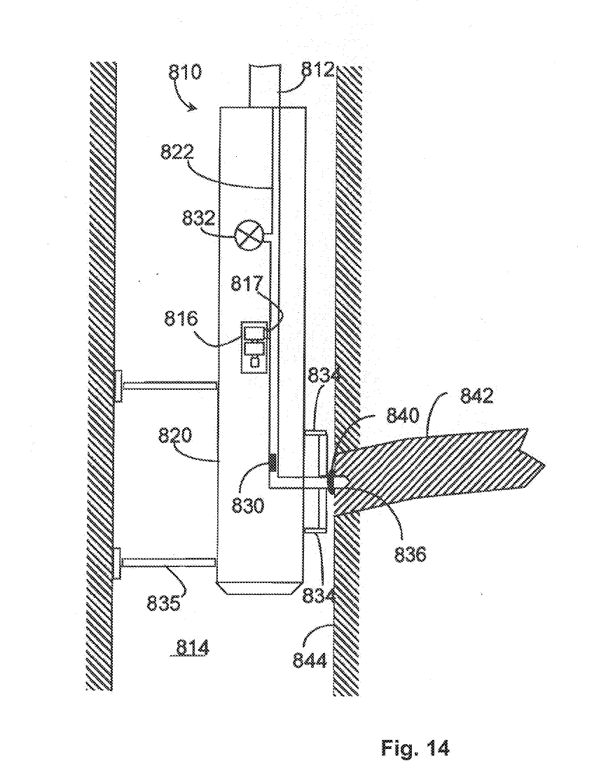

FIG. 14 shows a formation testing apparatus 810 held on a wireline 812 within a wellbore 814. The apparatus 810 is a well-known modular dynamic tester (MDT, Trade Mark of Schlumberger) as described in the co-owned U.S. Pat. No. 3,859,851 to Urbanosky, U.S. Pat. No. 3,780,575 to Urbanosky and U.S. Pat. No. 4,994,671 to Safinya et al., with this known tester being modified by introduction of an electrochemical analyzing sensor 816 substantially similar to sensor 50 of FIG. 16 The modular dynamics tester comprises body 820 approximately 30 m long and containing a main flowline bus or conduit 822. The analyzing tool 816 communicates with the flowline 822 via opening 817. In addition to the novel sensor system 816, the testing apparatus comprises an optical fluid analyzer 830 within the lower part of the flowline 822. The flow through the flowline 822 is driven by means of a pump 832 located towards the upper end of the flowline 822. Hydraulic arms 834 and counterarms 835 are attached external to the body 820 and carry a sample probe tip 836 for sampling fluid. The base of the probing tip 836 is isolated from the wellbore 814 by an o-ring 840, or other sealing devices, e.g. packers.

Before completion of a well, the modular dynamics tester is lowered into the well on the wireline 812. After reaching a target depth, i.e., the layer 842 of the formation which is to be sampled, the hydraulic arms 834 are extended to engage the sample probe tip 836 with the formation. The o-ring 840 at the base of the sample probe 836 forms a seal between the side of the wellbore 844 and the formation 842 into which the probe 836 is inserted and prevents the sample probe 136 from acquiring fluid directly from the borehole 814.

Once the sample probe 836 is inserted into the formation 842, an electrical signal is passed down the wireline 812 from the surface so as to start the pump 832 and the sensor systems 816 and 830 to begin sampling of a sample of fluid from the formation 842. The electrochemical sensor 816 can then measure the pH of the formation effluent.

While the preceding uses of the electrochemical sensor are in the hydrocarbon and water industries, embodiments of the present invention may provide an electrochemical sensor for measuring pH in a wide range of industries, including food processing, pharmaceutical, medical, water management and treatment, biochemistry, research laboratories and/or the like.

Electrodes may be made by a process which utilizes screen-printing onto a substrate. Stencil designs may delineate the components of the electrode. Constituents of the electrode may possibly be sequentially deposited onto the electrode. By way of example, carbon/graphite may be deposited onto an insulating substrate, which may comprise a plastic, polyester and/or the like. The carbon/graphite will provide a conducting substrate area. A reference electrode, such as silver/silver-chloride may then be deposited as a paste onto the electrode. The phenolic compound may be applied to the area printed with carbon/graphite and then electrochemically oxidized and polymerized.

A polymer coating on top of an electrode may prevent diffusion of a redox species from the working electrode, but still allow for interactions between an analyte and one or more of the redox species disposed on the working electrode. FIG. 15 is a schematic representation of a working electrode 111 with polymer coating 110 over a lower portion of the working electrode. This working electrode 111 comprises a deposit 114 formed from a phenolic compound and a reference redox species 123 connected by conductive tracks on the substrate of the electrode 111. The deposit 114 is sensitive to the pH of liquid 125 in contact with the electrode 111.

This electrode 111 could be used in combination with a hand-held potentiostat, for instance to measure pH of a sample in a beaker 127 as shown in FIG. 15. However, an electrode with a polymer coating such as electrode 111 could also be incorporated into apparatus for automated sampling, such as electrode 60 shown in FIG. 12 or be used in other equipment for processing aqueous liquid where a programmable computer receives measurement data from the electrode 111.

A polymer coating 110 may serve to prevent leaching, diffusion and/or the like of the redox species 114, 123 into the surrounding fluid. This may be important where it is not desirable to contaminate the fluid, for example the fluid may be water in a water treatment process, a batch of a pharmaceutical process, a food substance or the like. In other aspects, the electrochemical sensor/working electrode may be subject to human contact in use and it may be desirable to prevent such contact with the redox species. Alternatively or in addition, the application of the polymer coating 110 to the working electrode 111 may serve to anchor the redox species 114, 123 to the working electrode 111. As such, methods of fabrication of the working electrode may be used wherein the redox species are not chemically coupled to the working electrode 111. At the same time, the polymer coating 110 should allow the fluid 125 to permeate, diffuse or otherwise come into contact with the redox species 114 and 123 on the working electrode 111. Merely by way of example the polymer coating 110 may comprise a polysulphone polymer or a polystyrene polymer. Other polymers may be used provided the polymers do not interfere with the operation of the sensor. Methods to deposit the polymer coating 110 in a generally uniform layer over the working electrode 111 include spin coating onto the working electrode 111, dip coating onto the working electrode 111, and application using solvent evaporation onto the working electrode 111.

It will be appreciated that the example embodiments described in detail above can be modified and varied within the scope of the concepts which they exemplify. Features referred to above or shown in individual embodiments above may be used together in any combination as well as those which have been shown and described specifically. Accordingly, all such modifications are intended to be included within the scope of this disclosure as defined in the following claims.

1. A method of measuring the pH of an aqueous liquid wherein the concentration of buffer is not greater than 0.01 molar, comprising:
preparing a sensor electrode by applying a phenolic compound to a conductive substrate,
where the phenolic compound has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group;
electrochemically oxidising the phenolic compound in a one electron one proton oxidation so as to form a polymeric, water-insoluble, redox-active deposit on the conductive substrate; and
exposing the aqueous liquid to the sensor electrode and observing the redox reaction of the deposit on the sensor electrode.

2. A method according to claim 1, wherein the oxygen atom is part of a carbonyl, sulfonyl or nitro group attached to the said adjacent carbon atom of the ring.

3. A method according to claim 1, wherein the oxygen atom is part of a ketone, aldehyde or ester group attached to the said adjacent carbon atom of the ring.

4. A method according to claim 1, wherein the phenolic compound is free of ionized or ionisable amino, carboxylic acid or sulphonic acid groups.

5. A method according to claim 1, wherein the phenolic compound contains a single phenolic hydroxyl group.

6. A method according to claim 1, wherein observing the redox reaction comprises applying variable potential to the sensor electrode and determining the applied potential at a maximum current for redox reaction of the compound.

7. A method according to claim 1, wherein the aqueous liquid is unbuffered water.

8. A method according to claim 1, wherein the aqueous liquid contains buffer at a concentration of at least 10⁻⁶ molar.

9. A method according to claim 1, wherein the sensor electrode further comprises a second redox active compound as a reference, immobilized to the electrode, the oxidation and reduction of the second redox active compound being substantially insensitive to pH of the aqueous liquid.

10. A method of making an electrode for the determination of pH, which comprises:
depositing a phenolic compound on a conductive substrate,
where the phenolic compound has a phenolic hydroxy group attached to a carbon atom on an aromatic ring and also has an oxygen atom connected through one other atom to an adjacent carbon atom of the aromatic ring, such that said oxygen atom can form a hydrogen bond to the phenolic hydroxy group; and
electrochemically oxidising the immobilized phenolic compound in a one electron one proton oxidation so as to form a polymeric, water-insoluble, redox-active deposit on the conductive substrate.

11. A method according to claim 10, wherein deposition comprises applying a solution or suspension of the phenolic compound in a liquid, which evaporates to leave the compound on the conductive substrate.

12. A method according to claim 10, wherein the oxygen atom is part of a carbonyl, sulfonyl or nitro group attached to the said adjacent carbon atom of the ring.

13. A method according to claim 10, wherein the oxygen atom is part of a ketone, aldehyde or ester group attached to the said adjacent carbon atom of the ring.

14. A method according to claim 10, wherein the phenolic compound is free of ionized or ionisable amino, carboxylic acid or sulphonic acid groups.

15. A method according to claim 10, wherein the phenolic compound contains a single phenolic hydroxyl group.
